(19) United States
(12) Patent Application Publication
(10) Pub. No.: US 2003/0051179 A1
(43) Pub. Date: Mar. 13, 2003

(54) Method and apparatus for power management of displays

(76) Inventors: Aaron M. Tsirkel, San Jose, CA (US); Guy M. Therien, Beaverton, OR (US); Daniel J. Lenehan, Los Altos Hills, CA (US)

Correspondence Address: INTEL CORPORATION, P.O. BOX 5326, SANTA CLARA, CA, 95056-5326, US

(21) Appl. No.: 10/033,551

(22) Filed: Dec. 27, 2001

Related U.S. Application Data
(63) Continuation-in-part of application No. 09/952,113, filed on Sep. 13, 2001.

(51) Int. Cl. G06F 1/26

(52) U.S. Cl. 713/300

(57) ABSTRACT

A power management apparatus includes a sensor and a display. For one embodiment, power to the display may be decreased when the sensor detects absence of a user, and the power to the display may be increased when the sensor detects presence of the user.

This patent application is a continuation-in-part of U.S. patent application Ser. No. 09/952,113, filed Sep. 13, 2001.

The present invention relates generally to computer systems and more specifically to power management for displays.

### BACKGROUND

Computer systems are becoming increasingly pervasive in our society, including everything from small handheld electronic devices, such as personal data assistants and cellular phones, to application-specific electronic components, such as set-top boxes and other consumer electronics, to medium-sized mobile and desktop systems to large workstations and servers. To provide more powerful computer systems for consumers, designers strive to continually increase the operating speed of the processor. Unfortunately, as processor speed increases, the power consumed by the processor tends to increase as well. Historically, the power consumed by a computer system has been limited by two factors. First, as power consumption increases, the computer tends to run hotter, leading to thermal dissipation problems. Second, the power consumed by a computer system may tax the limits of the power supply used to keep the system operational, reducing battery life in mobile systems and diminishing reliability while increasing cost in larger systems.

One approach to reducing power consumption of a computer system is based on a Display Power Management System (DPMS) protocol. DPMS is used to selectively shut down parts of the computer system's video display circuitry after a period of inactivity. With a motherboard and display that support DPMS, power consumption can be greatly reduced. The motherboards that support DPMS often have a BIOS (basic input/output system) setting to enable the power consumption option. The BIOS setting controls a length of time the system must be idle (i.e., no activity detected from the user) for the display to be powered off. The idle time (or time out value) expiration value is specified in minutes or hours, or it may be set to “Disabled” or “Never”. The system then tries to detect user's activity including, for example, keyboard input and mouse movement. When there is no activity detected, the system sends appropriate control signals to the display to power it off in response to expiration of the time out value (i.e. after the time out value reaches the predetermined expiration value). Once the display is powered off, the system sends appropriate control signals to the display to power it on in response to the system detecting user's activity,.

Another approach to power management is by setting user's preference using the operating system or application software. For example, power to the display can be managed by setting a power off option in a power management properties menu to a certain fixed expiration value. The expiration value may be set to any value provided in a pop-up window ranging from 1 minute to “never”. The expiration value is static and remains the same until another value is selected.

### BRIEF DESCRIPTION OF THE DRAWINGS

The present invention is illustrated by way of example, and not limitation, in the figures of the accompanying drawings in which like references indicate similar elements and in which:

FIG. 1 is a timing diagram illustrating an approach to managing a display;

FIG. 2 is an illustration of one embodiment of a system used to conserve power consumption by a display;

FIG. 3 is a flow diagram illustrating one embodiment of a power management process using a sensor;

FIGS. 4A and 4B are timing diagrams to illustrate one example of reducing power to a display using a sensor-based method of the present invention in comparison with an alternate approach to managing the display;

FIG. 5A is a flow diagram illustrating one embodiment of a power management process using a sensor-based method in conjunction with a time-based method;

FIG. 5B is a flow diagram illustrating another embodiment of a power management process using a sensor-based method in conjunction with a time-based method;

FIG. 6 is a block diagram illustrating one embodiment of a driver-based user detection system using a sensor; and

FIG. 7 is an example of a computer system implemented with a sensor.

### DETAILED DESCRIPTION

A method of using a sensor to detect presence of a user to manage power consumption of a system is disclosed. The sensor monitors absence or presence of the user and generates control signals to allow increasing or decreasing power to a display.

Typically, at boot time, the display is powered on. Then a time based power management scheme may be invoked. A triggering event such as, for example, a keyboard input or a movement of a mouse, may reset the time out value to zero. When the time out value expires (i.e. reaches the predetermined expiration value) prior to a triggering event, power to the display may be decreased, including, for example, powering off the display. While the display is powered off, a triggering event may cause the display to be powered on and the time out value reset to zero.

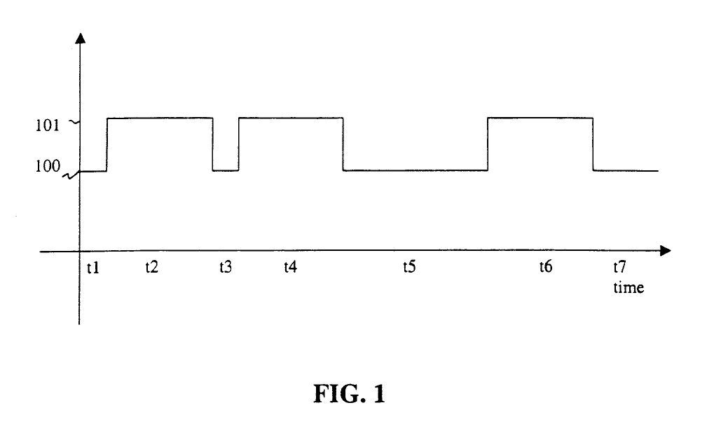

FIG. 1 is a timing diagram illustrating one example of an approach to power management of a display in accordance with an embodiment of the present invention. Time progresses from the left to right on the horizontal axis. The vertical axis illustrates two different power states of a display, an active state 101 and an inactive state 100. During the active state 101, the display may be powered on, and during the inactive state 100, the display may be powered off. Alternatively, power to the display may be merely greater during active state 101 than during inactive state 100. For example, the display may be brighter during active state 101, thereby consuming more power than during inactive state 100, when the display may be dimmer. Thus, during time intervals t1, t3, t5, and t7, power to the display may be lower (e.g. the display may be dimmer). During time intervals t2, t4, and t6, power to the display may be higher (e.g. the display may be brighter).

In this example, a triggering event occurring at the end of the time interval t1 may cause power to the display to be increased at the start of the time interval t2. In this example, the triggering event may be movement of the mouse or keyboard input. The occurrence of the triggering event may indicate that a user is in front of or near the display, and the time out value is reset to zero. Even though there is no additional triggering event occurring during the time intervals t2, t4, and t6, the display remains at a higher power consumption level until the time out value expires. One disadvantage of this approach is that the length of the time intervals t2, t4, and t6 may be the same even though the user may not be in front of the display. Leaving the display bright without presence of the user may result in wasted power consumption by the display.

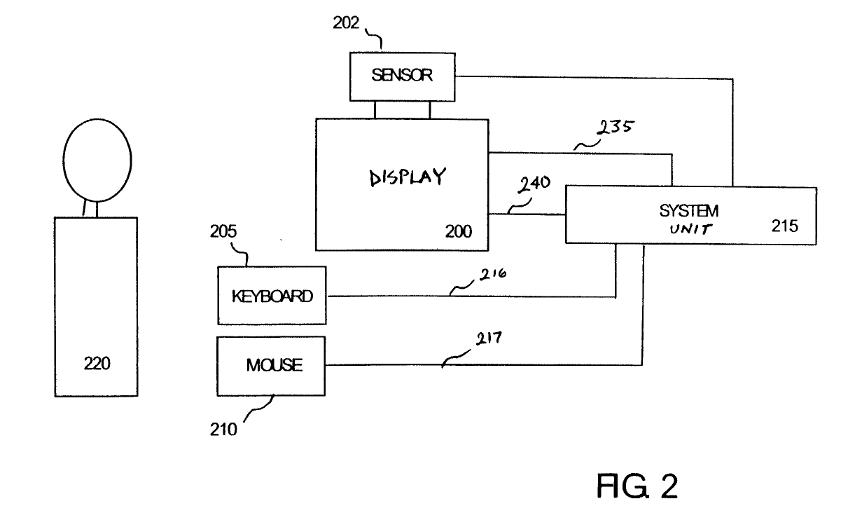

FIG. 2 is an illustration of one embodiment of a system used to reduce power consumption by a display. The system includes a system unit 215. A keyboard 205 is connected to the system unit 215 using connection 216. A mouse 210 is connected to the system unit 215 using connection 217. A display 200 may be connected to the system unit 215 using connection 235. In this example, the display 200 receives its power from the system unit 215 using connection 240. The power to the system unit 215 may be provided by a battery (not shown), or it may come from an electrical outlet (not shown). Typically, a user 220 is positioned near or in front of the display 200.

For one embodiment, a sensor device 202 may be used to detect if a user is present in front of or near the display 200. The sensor device 202 may be an infrared thermal sensor device (ITSD) including an infrared thermal sensor. The sensor device 202 may be capable of detecting the presence or absence of a user via the detection of the user's heat signature.

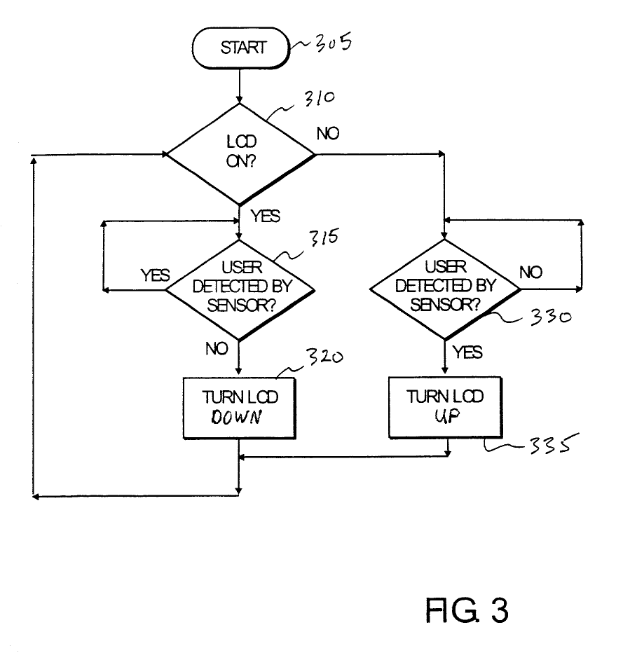

FIG. 3 is a flow diagram illustrating one embodiment of a user detection process by a computer system. The process starts at block 305. At block 310, a determination is made to see if the display, which may be a liquid crystal display (LCD) is currently powered on. When a display is powered on, it is in its normal, operating state in which the display image may be comfortably visible to the user at a brightness level that may be adjusted by the user. If the display is powered on, the process moves to block 315, where it is determined if a user is present. For one embodiment, this determination may be performed by detecting a change in the temperature of a “sensing” area in front of the display to sense the temperature generated by the user. For example, when a temperature sensed by a sensor of the system is lower than a previously sensed temperature, it may be an indication that the user has left the sensing area in front of or near the display. Conversely, when the temperature sensed by the sensor is higher than a previously sensed temperature, it may be an indication that the user has returned to the sensing area.

At block 315, when the display is on and the user is detected, the process is in a wait state until there is a change in the temperature. From block 315, when the user is determined to be absent (e.g., when the temperature sensed by the sensor is lower than a previously sensed temperature), the power to the display is decreased, as shown in block 320. Power to the display may be decreased by turning down (or dimming) the display brightness level. For one embodiment, the brightness level may be reduced to zero, thereby essentially powering off the display. The user detection process continues at block 310.

From block 310, when the display is powered off or is in a low power state, the process moves to block 330, where a determination is made to see if a user is detected by the sensor. If the user is determined to be absent, the process is in a wait state until there is a change in the temperature. From block 330, when the user is determined to be present (e.g., when the temperature sensed by the sensor is higher than a previously sensed temperature), the display is powered on by increasing the power to the display, as shown in block 335. Power to the display may be increased by turning up the display brightness level. For one embodiment, the brightness level may be increased to a level predetermined by the user, placing the display back in its normal, operating state in which the display image may be comfortably visible to the user

Thus, using the process illustrated in FIG. 3, the increasing and decreasing of power to the display may be more responsive to presence and absence of the user. When the user leaves the sensing area, power to the display may be decreased without having to wait for the time out value to expire. When the user returns to the sensing area, the display may be powered on.

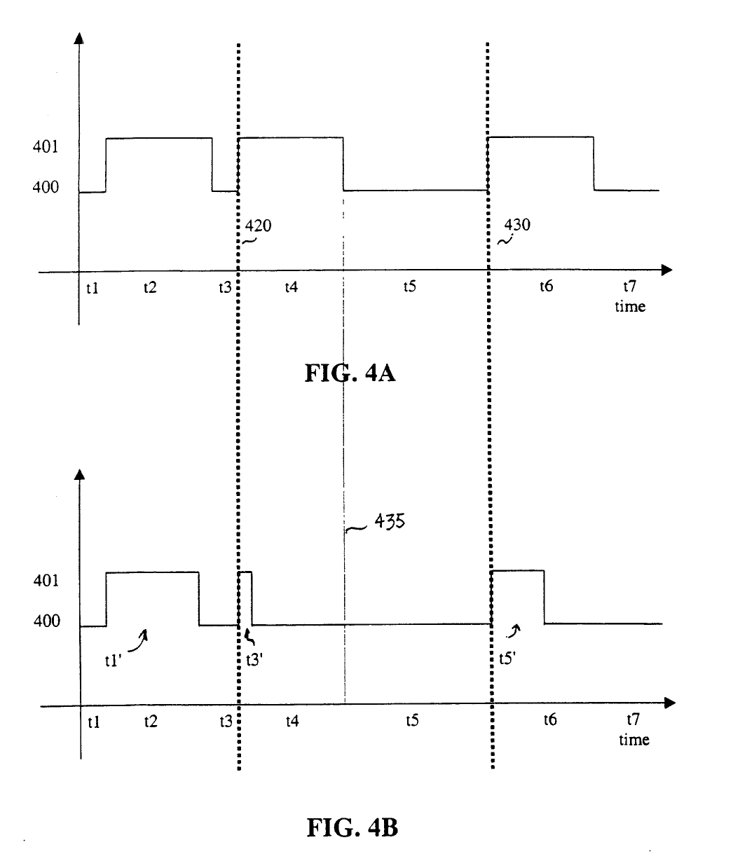

FIG. 4A is a timing diagram representing an approach similar to that illustrated in FIG. 1. FIG. 4B is a timing diagram representing the sensor-based approach of an embodiment of the present invention. FIGS. 4A and 4B are illustrated together for comparison purposes. The dotted lines 420 and 430 represent a beginning and an ending time of a time window used for the comparison. The line 435 is used to illustrate an ending time of the time interval t4 for both FIG. 4A and FIG. 4B. The level 401 represents a state in which power to the display is greater than power to the display associated with level 400.

Referring to FIG. 4A, the time interval t4 represents the time out expiration value set by the user. The display may be powered on at the beginning of the time interval t4 because an activity is detected from the user. The display may remain powered on while receiving no input from the user, even though the user may have left the area soon after a beginning of the time interval t4. Power to the display may be decreased at a beginning of the time interval t5. The display may remain in a lower power state during the time interval t5 until receiving a user's activity (e.g., keyboard input from the user) at a beginning of the time interval t6.

Referring to FIG. 4B, the time intervals t4 and t5 are the same as those in FIG. 4A. The time interval t3′ (t3 prime) is a subset of the time interval t4 and represents a length of time that the display is powered on because the sensor senses presence of the user. In this example, power to the display may be decreased at an end of the time interval t3′ if the user is determined to be absent. Power to the display may be increased at the beginning of the time interval t6 if the user is again detected. Thus, the length of time spent in a lower power state is t5+t4−t3′. This may be longer than the time interval t5 illustrated in FIG. 4A. The time interval t1′ (t1 prime) and the time interval t5′ (t5 prime) in FIG. 4B illustrate different higher power time intervals. Note that, in this example, the length of time the display spends in the lower power state using the sensor-based method is generally longer than that associated with the time out expiration method. The sensor-based method may eliminate the time between the user's absence and power to the display being decreased under the time-based approach. Because the display power may comprise a large percentage of the power consumed by a typical system, the power savings using the sensor-based method can be significant.

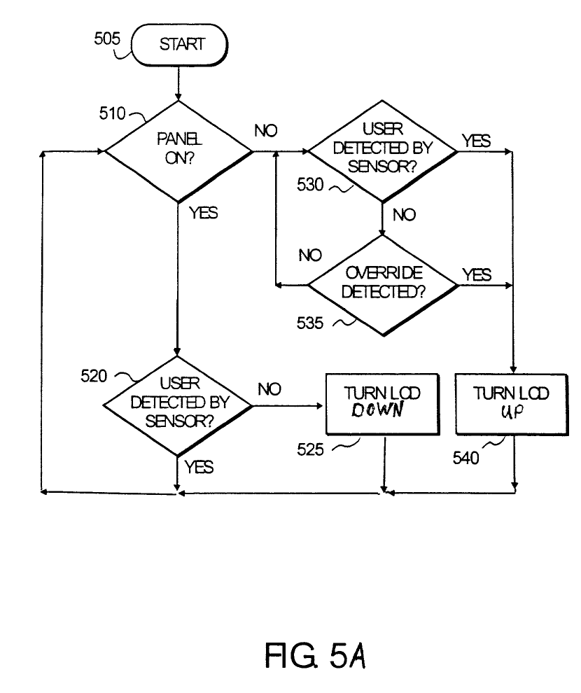

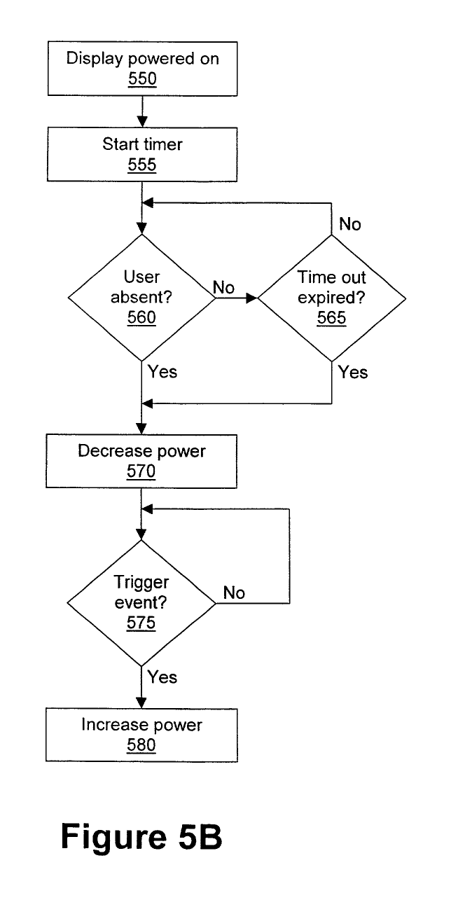

FIG. 5A is a flow diagram illustrating one embodiment of a power management process using a sensor-based method in conjunction with a time-based method. The process starts at block 505. At block 510, a determination is made to see if the display is currently powered on. If the display is powered on, the time out value may be continually reset by user's activity (e.g., keyboard input, mouse movement, etc.). Eventually, the time out value may expire if there is no user's activity. Note that the expiration of the time out value may be disabled by software applications such as, for example, DVD player applications. For one embodiment, the time out expiration value may be set to a minimum configurable value. This may allow for a reduced wait time using the time-based method before the sensor-based method takes over. If the time out value expires, the process moves to block 520.

At block 520, a determination is made to see if the sensor detects presence of a user. Note that using the time-based approach described above, the display may be powered off even though the user may still be present. For example, when the time out expiration value is set to one minute, the display can be powered off while the user is viewing data being displayed but not generating any input activity prior to the expiration of the time out value. This situation is avoided by the determination performed in block 520.

From block 520, when the user is determined to be present, the process moves back to block 510 to wait for the length of time specified by the time out expiration value until the user is not detected. From block 520, when the user is not detected (e.g., the user has moved away from the area in front of the display), the process moves to block 525 where power to the display is decreased. The process continues at block 510.

From block 510, when the display is not powered on, the process moves to block 530 where a determination is made to see if the sensor detects presence of the user. When the sensor detects the user, the process moves to block 540 where the display may be powered on. The process then continues at block 510.

From block 530, when the sensor does not detect the presence of the user, the process moves to block 535 where a determination is made to see if an override is detected. The override may be any triggering event that causes the display to be powered on. For example, the override may be an input generated by the user remotely using a remote controlled mouse. Being in a remote location (e.g., across a room), the user may not be detected by the sensor. When an override is not detected, the process moves from block 535 back to block 530 to wait for the sensor to detect the user or to wait for an override to occur. When an override is detected, the process moves from block 535 to block 540 where the display is powered on. The process then continues at block 510.

FIG. 5B is a flow diagram illustrating another embodiment of a power management process using a sensor-based method in conjunction with a time-based method. At step 550 the display is powered on. At step 555 the time out value timer is started. At step 560 it is determined, using the sensor, if the user is absent. If the user is determined to be present, it is determined if the timer has reached the time out expiration value, thereby resulting in the expiration of the time out value. Steps 560 and 565 continue until either the user is determined to be absent or the time out value expires, in which case power to the display is decreased at step 570. Not that in accordance with this embodiment of the present invention, power to the display may be decreased even though the user may be present.

At step 575 the system awaits a triggering event before power to the display is again increased at step 580. The triggering event may depend, at least in part, on the event that triggered power to the display to be decreased at step 570. For example, if power to the display is decreased at step 570 in response to determining that the user is absent at step 560, then a determination that the user is present, using the sensor, may be the triggering event at step 575. Alternatively, if power to the display is decreased at step 570 in response to expiration of the time out value at step 565, then user activity (e.g. keyboard input, mouse movement, or other input) may be the triggering event at step 575. In accordance with one embodiment of the present invention, power to the display is decreased at step 570 in response to expiration of the time out value at step 565, and it is subsequently determined, using the sensor, that the user becomes absent while the display is in the low power state. For this embodiment, a detection, using the sensor, of user presence may be the triggering event at step 575.

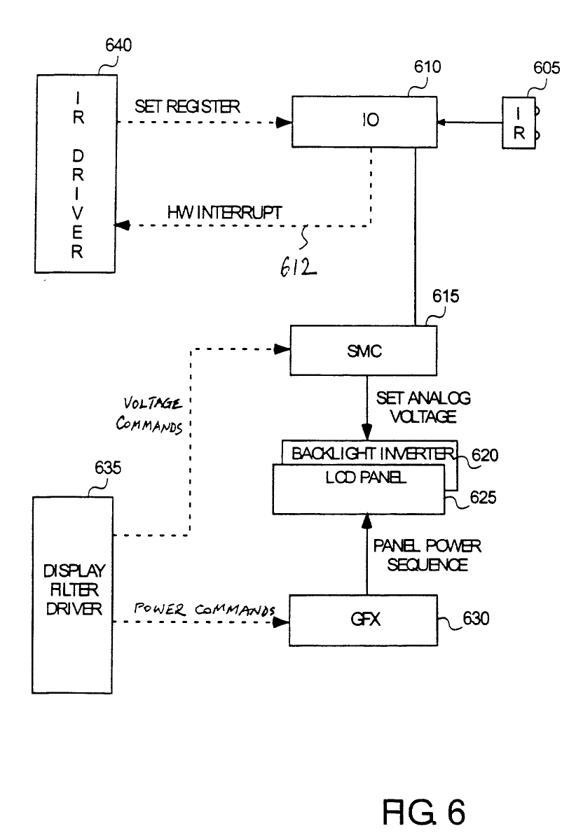

FIG. 6 is a block diagram illustrating one embodiment of a driver-based user detection system using a sensor. The detection system may be implemented using drivers and includes an infrared thermal sensor device (ITSD) 605 coupled with an I/O controller 610. The ITSD 605 may include an infrared thermal sensor and latch with a register based programmatic interface.

The I/O controller 610 may provide an interface (e.g., RS232) for the ITSD 605. The I/O controller 610 may also provide a hardware interrupt interface such that when the sensor on the ITSD 605 detects a change in the user presence state, a hardware interrupt 612 may be generated. The I/O controller 610 may be coupled with a system management controller 615 that may provide analog voltage to a backlight inverter 620. The backlight inverter 620 may be coupled with a display panel 625. A graphics controller 630 may control the display panel 625 and power to the backlight inverter 620.

A sensor driver 640 may be used to configure the ITSD 605 for sensor signal strength, pulse rate, etc. The sensor driver 640 may be used by a power management program to provide input options to configure the ITSD 605. The input options may then be used to set register values in the I/O controller 610. The sensor driver 640 may also handle hardware interrupt requests generated by the I/O controller 610 by sending signal events to the power management program.

A display filter driver 635 may send commands to the system management controller 615 to program the analog voltage to the backlight inverter 620. The display filter driver 635 may also send power commands to a display subsystem (not shown) to increase or decrease power to the display panel 625, the backlight inverter 620, and the graphics controller 630. The display filter driver 635 may be used by the power management program to set the display power when there is a change to a presence state of the user (e.g., the user leaves the area or the user comes back to the area). In this example, the system may remain in an idle state until it receives an interrupt generated by the I/O controller 610. The interrupt may be generated when the sensor detects a change to the presence state of a user. In an alternative embodiment, the power management program may periodically poll the I/O controller 610 to determine if the sensor in the ITSD 605 detects a change in the user presence state.

Although the above description refers to a temperature-sensing device, other types of sensor may also be used to detect the user's presence. In one embodiment, the sensor is an acoustic (sonic) distance sensor generating sound waves to detect the user's presence. The sound waves are bounced off the user and the distance between the user and the display may be calculated. When the distance is beyond a threshold, the user may be perceived to have left the sensing area, and power to the display may be decreased. While the display is in a low power state, the sensor may send sound waves and detect distances. If the distance is found to be within the threshold, the display may be powered on.

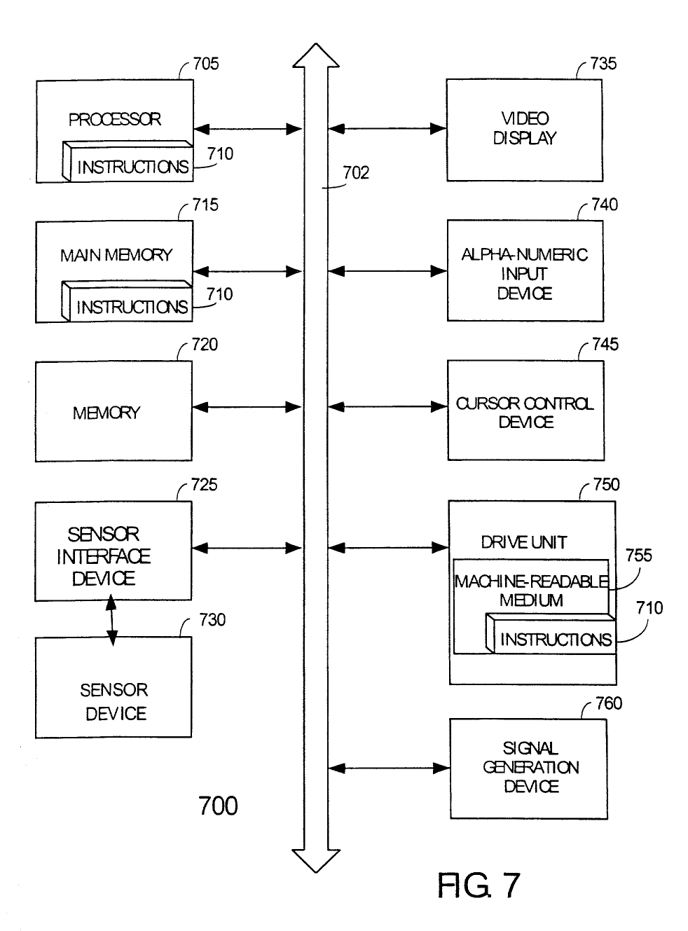

FIG. 7 is an example of a computer system implemented with the sensor described above. The computer system 700 includes a processing unit 705 coupled with a bus 702. Other devices coupled with the bus include a video display 735, an alphanumeric input device 740 (e.g., a keyboard), and a cursor control device 745 (e.g., a mouse). The computer system 700 also includes a sensor device 730 coupled with a sensor device interface 725 to sense absence or presence of the user. The sensor interface device 725 is coupled with the bus 702 to send interrupt signals. Also coupled with the bus 702 is a signal generation device 760 to generate signals in response to the interrupts generated by the sensor interface device 725.

The operations of the various methods of the present invention may be implemented by sequences of computer program instructions 710 which are stored in a memory which may be considered to be a machine readable storage media 755. The memory may be random access memory, read only memory, a persistent storage memory, such as mass storage device 720 or any combination of these devices. Execution of the sequences of instructions 710 causes the processing unit 705 to perform operations according to the present invention, including the operations described in FIG. 3 and/or the operations described in FIGS. 5A-B. The instructions 710 may be loaded into a main memory 715 of the computer system from a storage device or from one or more other digital processing systems (e.g. a server computer system) over a network connection. The instructions 710 may be stored concurrently in several storage devices (e.g. DRAM and a hard disk, such as virtual memory). Consequently, the execution of the instructions 710 may be performed directly by the processing unit 705.

In other cases, the instructions 710 may not be performed directly or they may not be directly executable by the processing unit 705. Under these circumstances, the executions may be executed by causing the processing unit 705 to execute an interpreter that interprets the instructions, or by causing the processing unit 705 to execute instructions which convert the received instructions 710 to instructions which can be directly executed by the processing unit 705. In other embodiments, hard-wired circuitry may be used in place of or in combination with software instructions to implement the present invention. Thus, the present invention is not limited to any specific combination of hardware circuitry and software, nor to any particular source for the instructions executed by the computer or digital processing system.

This invention has been described with reference to specific exemplary embodiments thereof. It will, however, be evident to persons having the benefit of this disclosure that various modifications and changes may be made to these embodiments without departing from the broader spirit and scope of the invention. The specification and drawings are, accordingly, to be regarded in an illustrative rather than a restrictive sense.

What is claimed is:

1. A system, comprising:
a sensor; and
a display, power to which is to be decreased in response to a detection of absence of a user by the sensor.

2. The system of claim 1, wherein the power is to be increased in response to a detection of presence of a user by the sensor.

3. The system of claim 2, wherein the power is to be decreased in response to expiration of a time out value.

4. The system of claim 1, wherein the power is to be decreased in response to the expiration of a time out value.

5. The system of claim 1, wherein the sensor is an infrared thermal sensor.

6. The system of claim 1, wherein the sensor is an acoustic sensor.

7. A method, comprising:
providing a computer system with a sensor to detect absence of a user; and enabling power to be decreased to a display of the computer system in response the sensor detecting absence of a user.

8. The method of claim 7, further comprising enabling power to be increased to the display in response to the sensor detecting presence of a user.

9. The method of claim 8, further comprising enabling power to be decreased to the display in response to a time out value expiring.

10. The method of claim 7, further comprising enabling power to be decreased to the display in response to a time out value expiring.

11. The method of claim 7, wherein providing the computer system with a sensor includes providing the computer system with an infrared thermal sensor or an acoustic sensor.

12. The method of claim 7, wherein enabling power to be decreased includes coupling a controller to the sensor, the controller to receive a signal from the sensor and to control power to the display.

13. A machine readable medium including machine readable instructions that, if executed by a computer system, cause the computer system to perform a method comprising:
determining if a user is absent; and
decreasing power to a display of the computer system if it is determined that the user is absent.

14. The medium of claim 13, wherein the method further comprises increasing power to the display if it is determined that the user is present.

15. The medium of claim 14, wherein the method further comprises decreasing power to the display if a time out value expires.

16. The medium of claim 13, wherein the method further comprises decreasing power to the display if a time out value expires.

17. The medium of claim 13, wherein decreasing power to the display comprises powering off the display.
